(19) United States
(12) Patent Application Publication
(10) Pub. No.: US 2025/0389370 A1
(43) Pub. Date: Dec. 25, 2025

(54) MOVEABLE DEVICE SUPPORT APPARATUS

(71) Applicant: Antaeus Holdings, LTD., Dallas, TX (US)

(72) Inventor: Scott A. Everett, Dallas, TX (US)

(21) Appl. No.: 18/749,456

(22) Filed: Jun. 20, 2024

(51) Int. Cl. F16M 11/04

(52) U.S. Cl. CPC F16M 11/043; F16M 2200/06

(57) ABSTRACT

A device support apparatus includes a rail extending under a support surface. A bracket is coupled to the rail and an arm extends from the rail. A device bracket is coupled to an end of the arm and configured to couple to a device.

### BACKGROUND

The present disclosure relates to a support apparatus for a monitor, and particularly, to a moveable device support apparatus.

Generally, a monitor includes main body having a display for displaying an image. A base is seated on a surface to support the main body. Often, the base is not moveable along the surface and repositioning of the monitor requires lifting the base from the surface. Additionally, repositioning of the monitor often requires the movement of cables connected to the monitor.

### SUMMARY

The present disclosure includes one or more of the features recited in the appended claims and/or the following features which, alone or in any combination, may comprise patentable subject matter.

According to a first aspect of the disclosed embodiments, a device support apparatus that is moveable relative to a support surface includes a rail extending under the support surface. A moveable bracket is coupled to the rail and configured to move along a length of the rail. An arm extends from the rail. The arm extends through a slot in the support surface from beneath the support surface to above the support surface and moves along a length of the slot as the moveable bracket moves along the rail. A device bracket is coupled to an end of the arm. The device bracket is configured to couple to a device.

In some embodiments of the first aspect, the device may include an electronic device. Electrical cords of the electronic device may be passed through a channel formed in the arm. The channel may extend from a lower opening in a lower end of the arm that is positioned under the support surface and an upper opening in an upper end of the arm that is positioned above the support surface. The device bracket may be moveable relative to the arm to move the device relative to the arm. The device bracket may be coupled to an upper end of the arm. The moveable bracket may be coupled to a lower end of the arm. The moveable bracket may include at least one rolling mechanism that rolls along a surface of the rail. The at least one rolling mechanism may include at least one of a wheel and a ball bearing. A substantially frictionless connection between the moveable bracket and the rail may enable the moveable bracket to move along the length of the rail.

According to a second aspect of the disclosed embodiments, a support surface having a moveable device support apparatus includes a slot extending along a length of the support surface. A rail extends under the support surface. A moveable bracket is coupled to the rail and configured to move along a length of the rail. An arm extends from the rail. The arm extends through the slot from beneath the support surface to above the support surface and moves along the length of the slot as the moveable bracket moves along the rail. A device bracket is coupled to an end of the arm. The device bracket is configured to couple to a device.

In some embodiments of the second aspect, the support surface may include a table top. The slot may include a deformable material to seal the slot. The deformable material may deform to allow the arm to move through the slot. The device may include an electronic device. Electrical cords of the device may be passed through a channel formed in the arm. The channel may extend from a lower opening in a lower end of the arm that is positioned under the support surface and an upper opening in an upper end of the arm that is positioned above the support surface. The device bracket may be moveable relative to the arm to move the device relative to the arm. The device bracket may be coupled to an upper end of the arm. The moveable bracket may be coupled to a lower end of the arm. The moveable bracket may include at least one rolling mechanism that rolls along a surface of the rail. The at least one rolling mechanism may include at least one of a wheel and a ball bearing. A substantially frictionless connection between the moveable bracket and the rail may enable the moveable bracket to move along the length of the rail.

Additional features, which alone or in combination with any other feature(s), such as those listed above and those listed in the claims, may comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures in which:

FIG. 1 is a front elevation view of a support surface having a device support apparatus coupled thereto and supporting a device;

FIG. 2 is a top view of a support surface in accordance with an embodiment having a slot through which the device support apparatus extends;

FIG. 3 is a top view of a support surface in accordance with another embodiment having a slot through which the device support apparatus extends;

FIG. 4 is a side view of a post of the device support apparatus and a top bracket and a bottom bracket of the device support apparatus coupled to the post;

FIG. 5 is a top exploded view of the post and top bracket of the device support apparatus; and

FIG. 6 is a front view of the bottom bracket of the device support apparatus coupled to a rail of the device support apparatus.

### DETAILED DESCRIPTION

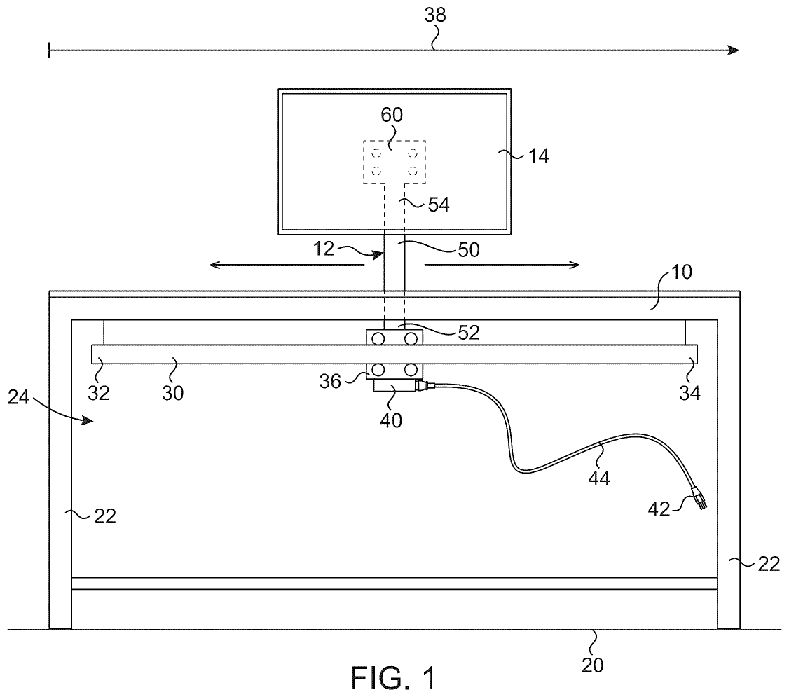

Referring to FIG. 1, a support surface 10 is embodied as a desk. It will be appreciated that in some embodiments the support surface is a table, a counter, a television stand, a work space, or the like. A device support apparatus 12 is coupled to the support surface 10 to support a device 14. In the exemplary embodiment, the device 14 is a computer monitor. It will be appreciated that is some embodiments, the device 14 is a picture or video display, such as an electronic picture frame, a monitor, or a television, or electronic equipment, such as music equipment, research equipment, scientific equipment, or the like.

The support surface 10 is raised from a floor 20 on legs or supports 22 so that a space 24 is formed below the support surface 10. The device support apparatus 12 includes a rail 30 extending through the space 24 under the support surface 10. The rail 30 extends between a first end 32 and a second end 34. A moveable bracket 36 is coupled to the rail 30 and configured to move along a length 38 of the rail 30 between the first end 32 and the second end 34. In the illustrative embodiment, an adaptor or transformer 40 of the device 14 is coupled to the moveable bracket 36 and configured to move with the moveable bracket 36 along the rail 30. A plug end 42 of an electrical cord 44 of the device 14 extends from the adaptor 40 is an configured to plug into a power outlet. For devices 14 that do not include an adaptor 40, the electrical cord 44 is coupled to the moveable bracket 36. The electrical cord 44 moves with the moveable bracket 36.

An arm 50 extends from the rail 30. More particularly, the arm 50 extends from a lower end 52 beneath the support surface 10 to an upper end 54 above the support surface 10. The lower end 52 is coupled to the moveable bracket 36 so that the arm 50 extend from the moveable bracket 36 and the arm 50 moves along the length 38 of the rail 30 as the moveable bracket 36 moves along the rail 30. A device bracket 60 is coupled to the upper end 54 of the arm 50. The device bracket 60 is coupled to the device 14. In exemplary embodiment, the device 14 is removeably coupled to the device bracket 60.

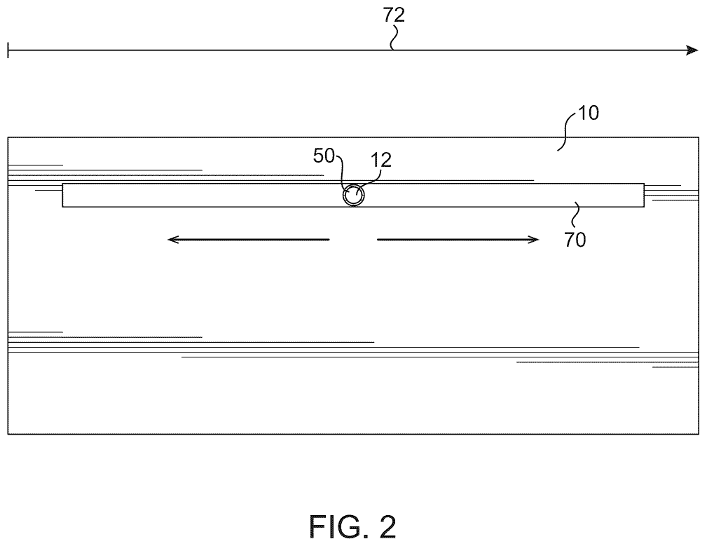

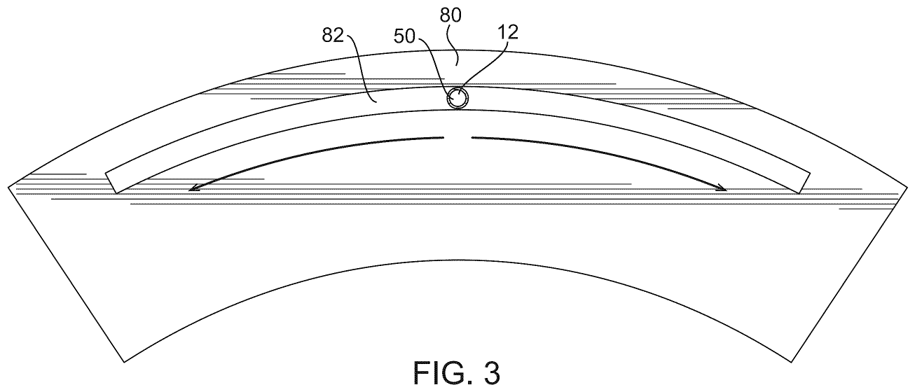

Referring now to FIG. 2, the support surface 10 has a slot 70 extending a length 72 across the support surface 10. FIG. 3 illustrates another exemplary support surface 80 that is curved and includes a curved slot 82. It will be appreciated that the support surface and the slot can have any suitable geometric configuration. The device support apparatus 12 extends through the slot 70. In particular, the arm 50 extends through the slot 70 from below the support surface 10 to above the support surface 10. The arm 50 moves along the length 72 of the slot 70 as the moveable bracket 36 moves along the rail 30 to move the device 14 relative to the support surface 10. In some embodiments the slot 70 includes a deformable material to seal the slot 70. The deformable material deforms to allow the arm 50 to move through the slot 70. In an exemplary embodiment, the slot 70 is sealed with a rubber component or bristles that deform to allow the arm 50 to pass through the slot 70.

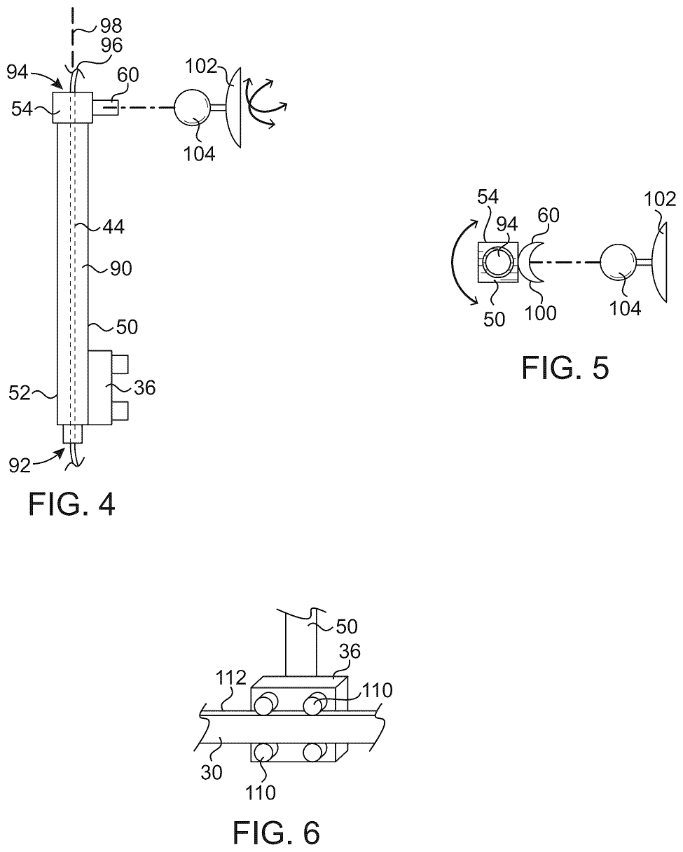

Referring now to FIG. 4, a channel 90 extends from a lower opening 92 formed in the lower end 52 of the arm 50 and an upper opening 94 formed in the upper end 54 of the arm 50. The electrical cord 44 of the device 14 are passed through the 90 channel formed in the arm 50. A device end 96 of the electrical cord 44 extends through the channel 90 from the adaptor 40 to the device 14. For devices 14 that do not include an adaptor 40, the electrical cord 44 extends through the channel 90 from the device 14 to a plug. As illustrated in FIG. 5, the arm 50 rotated about an axis 98 of the arm 50.

Referring to FIGS. 4 and 5, the device bracket 60 is coupled to the upper end 54 of the arm 50 and the moveable bracket 36 is coupled to the lower end 52 of the arm 50. The device bracket 36 includes a cup connector 100. A mounting bracket 102 is configured to couple to a back side of the device 14. The mounting bracket 102 includes a ball connector 104 that is configured to position in the cup connector 100 of the device bracket 36. It will be appreciated that, in some embodiments, the device bracket 36 includes the ball connector 104 and the mounting bracket 102 includes the cup connector 100. The connection between the device bracket 14 and the mounting bracket 102 enables the mounting bracket 102, and subsequently the device 14, to move relative to the arm 50 in three degrees of rotation. That is, the device 14 yaws, rolls, and pitches relative to the arm 50.

Referring now to FIG. 6, the moveable bracket 36 includes at least one rolling mechanism 110 that rolls along a surface 112 of the rail 30. In the exemplary embodiment, the rolling mechanism 110 includes wheels 114 that are positioned above and below the rail 30. In some embodiments, the rolling mechanism 110 includes at least one ball bearing secured in the moveable bracket 36 and configured to roll along the surface 112 of the rail 30. It will be appreciated that, in some embodiments, the moveable bracket 36 includes any suitable rolling mechanism 110 for moving along the rail 30. In some embodiments, the device support apparatus 12 includes a substantially frictionless connection between the moveable bracket 36 and the rail 30 to enable the moveable bracket 36 to move along the length 38 of the rail 30.

Any theory, mechanism of operation, proof, or finding stated herein is meant to further enhance understanding of principles of the present disclosure and is not intended to make the present disclosure in any way dependent upon such theory, mechanism of operation, illustrative embodiment, proof, or finding. It should be understood that while the use of the word preferable, preferably or preferred in the description above indicates that the feature so described can be more desirable, it nonetheless cannot be necessary and embodiments lacking the same can be contemplated as within the scope of the disclosure, that scope being defined by the claims that follow.

In reading the claims it is intended that when words such as “a,” “an,” “at least one,” “at least a portion” are used there is no intention to limit the claim to only one item unless specifically stated to the contrary in the claim. When the language “at least a portion” and/or “a portion” is used, the item can include a portion and/or the entire item unless specifically stated to the contrary.

It should be understood that only selected embodiments have been shown and described and that all possible alternatives, modifications, aspects, combinations, principles, variations, and equivalents that come within the spirit of the disclosure as defined herein or by any of the following claims are desired to be protected. While embodiments of the disclosure have been illustrated and described in detail in the drawings and foregoing description, the same are to be considered as illustrative and not intended to be exhaustive or to limit the disclosure to the precise forms disclosed. Additional alternatives, modifications and variations can be apparent to those skilled in the art. Also, while multiple inventive aspects and principles have been presented, they need not be utilized in combination, and many combinations of aspects and principles arc possible in light of the various embodiments provided above.

1. A device support apparatus that is moveable relative to a support surface, the device support apparatus comprising:
a rail extending under the support surface,
a moveable bracket coupled to the rail and configured to move along a length of the rail,
an arm extending from the rail, wherein the arm extends through a slot in the support surface from beneath the support surface to above the support surface and moves along a length of the slot as the moveable bracket moves along the rail, and
a device bracket coupled to an end of the arm, wherein the device bracket is configured to couple to a device.

2. The device support apparatus of claim 1, wherein the device includes an electronic device.

3. The device support apparatus of claim 2, wherein electrical cords of the electronic device are passed through a channel formed in the arm.

4. The device support apparatus of claim 3, wherein the channel extends from a lower opening in a lower end of the arm that is positioned under the support surface and an upper opening in an upper end of the arm that is positioned above the support surface.

5. The device support apparatus of claim 1, wherein the device bracket is moveable relative to the arm to move the device relative to the arm.

6. The device support apparatus of claim 1, wherein:
the device bracket is coupled to an upper end of the arm, and
the moveable bracket is coupled to a lower end of the arm.

7. The device support apparatus of claim 1, wherein the moveable bracket includes at least one rolling mechanism that rolls along a surface of the rail.

8. The device support apparatus of claim 7, wherein the at least one rolling mechanism includes at least one of a wheel and a ball bearing.

9. The device support apparatus of claim 1, wherein a substantially frictionless connection between the moveable bracket and the rail enables the moveable bracket to move along the length of the rail.

10. A support surface having a moveable device support apparatus, the support surface comprising:
a slot extending along a length of the support surface,
a rail extending under the support surface,
a moveable bracket coupled to the rail and configured to move along a length of the rail,
an arm extending from the rail, wherein the arm extends through the slot from beneath the support surface to above the support surface and moves along the length of the slot as the moveable bracket moves along the rail, and
a device bracket coupled to an end of the arm, wherein the device bracket is configured to couple to a device.

11. The support surface of claim 10, wherein the support surface includes a table top.

12. The support surface of claim 10, wherein the slot includes a deformable material to seal the slot, wherein the deformable material deforms to allow the arm to move through the slot.

13. The support surface of claim 10, wherein the device includes an electronic device.

14. The support surface of claim 13, wherein electrical cords of the device are passed through a channel formed in the arm.

15. The support surface of claim 14, wherein the channel extends from a lower opening in a lower end of the arm that is positioned under the support surface and an upper opening in an upper end of the arm that is positioned above the support surface.

16. The support surface of claim 10, wherein the device bracket is moveable relative to the arm to move the device relative to the arm.

17. The support surface of claim 10, wherein:
the device bracket is coupled to an upper end of the arm, and
the moveable bracket is coupled to a lower end of the arm.

18. The support surface of claim 10, wherein the moveable bracket includes at least one rolling mechanism that rolls along a surface of the rail.

19. The support surface of claim 18, wherein the at least one rolling mechanism includes at least one of a wheel and a ball bearing.

20. The support surface of claim 10, wherein a substantially frictionless connection between the moveable bracket and the rail enables the moveable bracket to move along the length of the rail.
